(19) United States
(12) Patent Application Publication
(10) Pub. No.: US 2013/0136524 A1
(43) Pub. Date: May 30, 2013

(54) Loose Leaf Retaining Device

(71) Applicants: Richard Louis Brophy, St. Louis, MO (US); Andrew Benjamin Whitehead, St. Louis, MO (US)

(72) Inventors: Richard Louis Brophy, St. Louis, MO (US); Andrew Benjamin Whitehead, St. Louis, MO (US)

(21) Appl. No.: 13/689,843

(22) Filed: Nov. 30, 2012

Related U.S. Application Data
(60) Provisional application No. 61/564,894, filed on Nov. 30, 2011.

(51) Int. Cl. B42F 13/00

(52) U.S. Cl. CPC B42F 13/002
USPC 402/70; 402/74

(57) ABSTRACT

In one aspect, a loose leaf retaining device includes a first panel and a second panel opposing the first panel. A hinged portion connects the first panel to the second panel, such that in a closed state, the first panel is disposed at a non-zero angle relative to the second panel. A frictional engagement member is disposed on an outside of at least one of the first panel and the second panel.

### CROSS REFERENCE TO RELATED APPLICATIONS

This application claims priority to provisional application Ser. No. 61/564,894, filed Nov. 30, 2011, the disclosure of which is hereby incorporated by reference in its entirety.

### FIELD

The field of the present disclosure relates generally to loose leaf retaining devices and methods. More particularly, the present disclosure relates to loose leaf retaining devices including an anti-slide device.

### BACKGROUND

Typically, loose leaf, such as paper and the like, is stored within a folder or binder. Such folders and binders typically include a front and back cover that are hingedly attached to one another. Most often, binders are formed with a paper retaining device on the hinged end. Such retaining devices, like that described in U.S. Pat. No. 7,296,946, are well known in the art. Normally, the hinged end of the binder has a greater thickness than the opposite end of the binder. This causes one cover of the binder to be disposed at a non-zero angle with respect to the other cover when the binder is closed and resting on a horizontal and level surface. Such angle causes undesirable slipping of one binder with respect to another when multiple binders are stacked on top of one another.

### BRIEF DESCRIPTION

In one aspect, a loose leaf retaining device includes a first panel and a second panel opposing the first panel. A connecting portion pivotally or hingedly connects the first panel to the second panel such that in a closed state, the first panel is disposed at a non-zero angle relative to the second panel. At least one of the first panel and the second panel of the loose leaf retaining device further comprises an engagement member capable of securing the first or second panel of the device to another such device to reduce or eliminate slipping.

In another aspect, a loose leaf retaining system includes a first binder comprising a first panel and a second panel, the first panel being pivotally or hingedly connected to the second panel thereof and a second binder comprising a first panel and a second panel, the first panel being pivotally or hingedly connected to the second panel thereof. At least one of the first panel and the second panel of the first binder comprises at least one engagement member and at least one of the first panel and the second panel of the second binder comprises at least one engagement member configured to interconnect or mate with the engagement member of the first binder.

In yet another aspect, a loose leaf binder includes a first panel, a second panel and a third panel, the third panel disposed intermediate the first panel and the second panel, the third panel being pivotally or hingedly connected to the first panel along a first edge and pivotally or hingedly connected to the second panel along a second edge. At least one of the first panel and the second panel includes an engagement member configured for interconnecting or mating with a corresponding engagement member of another loose leaf binder.

### BRIEF DESCRIPTION OF THE DRAWINGS

FIG. 1 is an exemplary perspective view of an embodiment of a loose leaf retaining device according to the present disclosure.

FIG. 2 is an exemplary side view of the loose leaf retaining device of FIG. 1 shown in a closed state and an opened state.

FIG. 3 is an exemplary side view of two loose leaf retaining devices of FIG. 1, in 180 degree opposed relation.

FIG. 4 is an exemplary side view of two loose leaf retaining devices of FIG. 3 shown interconnected.

FIG. 5 is a perspective view of an embodiment of a loose leaf retaining device having a raised edge according to the present disclosure.

FIG. 6 is an exemplary side view of two loose leaf retaining devices of FIG. 6, in 180 degree opposed relation and interconnected.

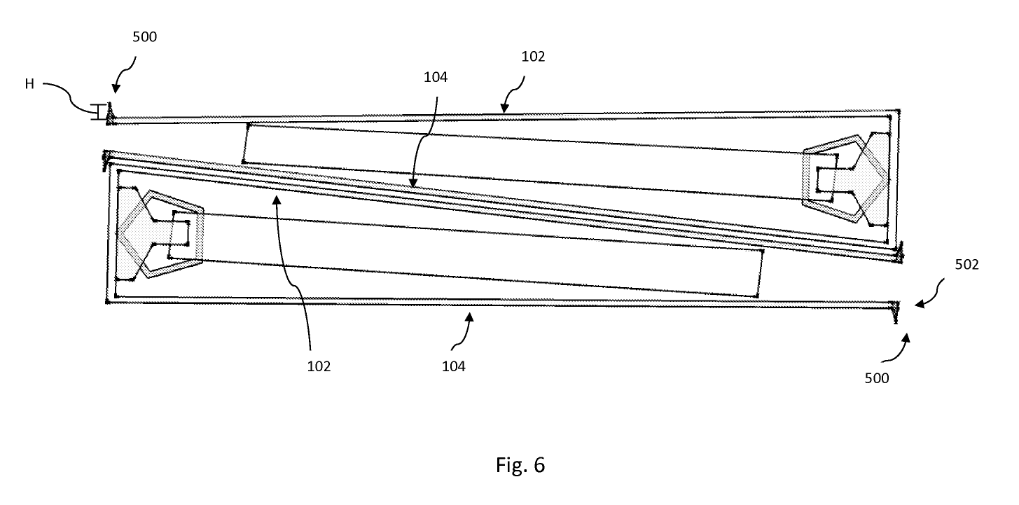

FIG. 7 is a side view of a loose leaf retaining device of FIG. 5.

FIG. 8 is an exemplary perspective view of an embodiment of a loose leaf retaining device according to the present disclosure.

FIG. 9 is an exemplary side view of two loose leaf retaining devices of FIG. 8, in 180 degree opposed relation and interconnected.

FIG. 10 shows an exemplary embodiment of a loose leaf retaining device according to the present disclosure.

FIG. 11 shows an exemplary side view of two loose leaf retaining devices of FIG. 10, in 180 degree opposed relation and interconnected.

### DETAILED DESCRIPTION

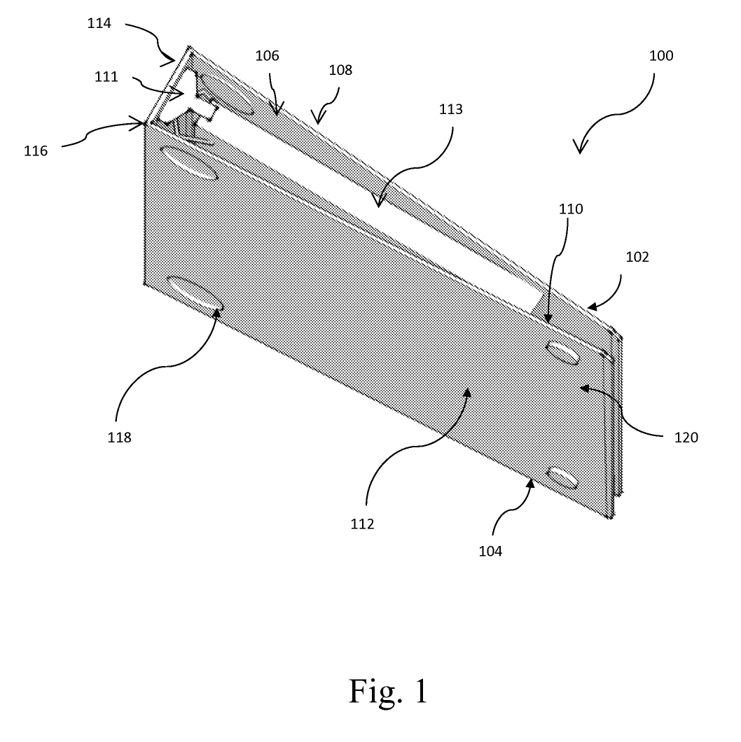

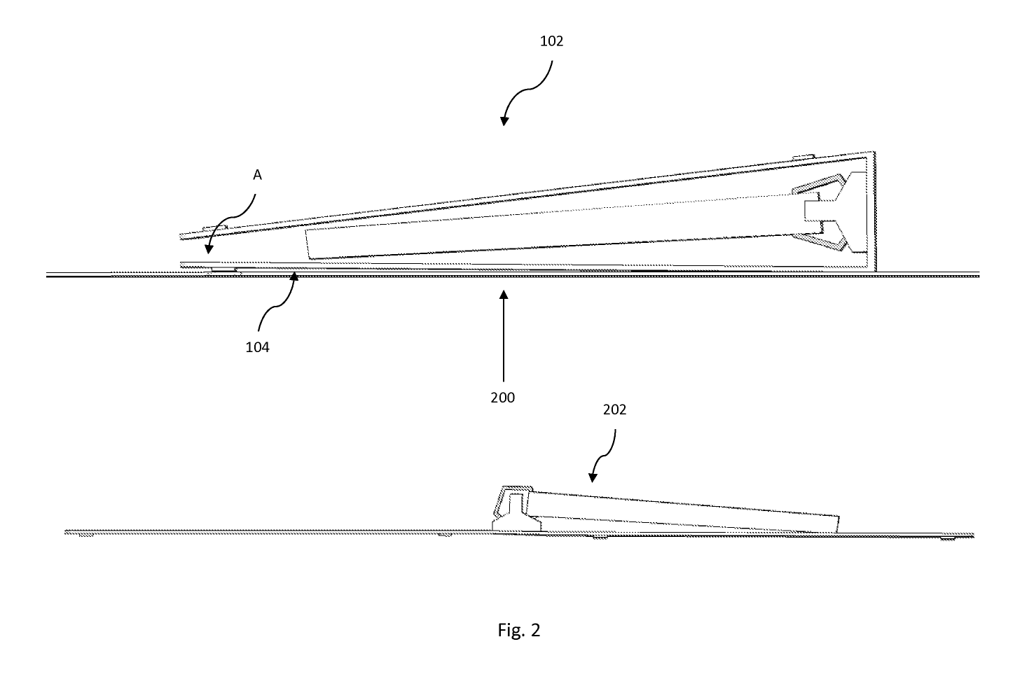

FIG. 1 illustrates an exemplary loose leaf retaining device 100. In one embodiment, loose leaf retaining device includes a first panel 102 and an opposing second panel 104. First panel 102 has an inner side 106 and an outer side 108. Second panel 104 has an inner side 110 facing inner side 106 of first panel 102 and an outer side 112. First panel 102 is hingedly connected to second panel 104 through hinged portion 114. As used herein, “hinge” or “hingedly” refers to a flexible connection such as a mechanical hinge, living hinge, flexible coupling or the like. In one embodiment, hinged portion 114 comprises or is fabricated from one or more flexible portions 116, for example an elastic material. Flexible portions 116 flexibly connect first panel 102 to second panel 104 and facilitates opening the loose leaf retaining device 100. In other embodiments, hinged portion 114 comprises a hinge such as a butt hinge, butterfly hinge, flush hinge, barrel hinge, concealed hinge, piano hinge and the like. In yet other embodiments, hinged portion 114 comprises a thin, weakened or perforated portion that provides flexibility. The loose leaf retaining device is shown, for example, in a closed state 200 and an open state 202 in FIG. 2.

In one embodiment, loose leaf retaining device 100 includes a third panel 122 disposed intermediate first panel 102 and second panel 104. Third panel 122 may be formed integrally with, or separately from, first panel 102 and/or second panel 104. Each of first panel 102, second panel 104 and third panel 122 are formed of one or more materials including cardboard, paper, plastic, fiberglass, wood, wood pulp, carbon fiber, metal, metal alloys and the like, or combinations thereof. In one embodiment, one or more of first panel 102, second panel 104 and third panel 122 are coated with a protective layer, such as a substantially water or vapor impermeable layer.

In one embodiment, first panel 102 is disposed at a non-zero angle A with respect to second panel 104 when in closed state 200. In one embodiment, the closed state 200 includes a distal end of first panel 102 being in contact with, or very near, a distal end of second panel 104. In an open state 202, first panel 102 and second panel 104 are substantially planar (i.e., lie on the same plane). In other embodiments, the loose leaf retaining device 100 may be open to any extent that allows the loose leaf retaining device to function as described herein.

In one embodiment the loose leaf retaining device includes a loose leaf holding device 111. In some embodiments, loose leaf holding device 111 is a clamp, ring metal, 3-ring device, coil, clip, adhesive or the like, or combinations thereof. Loose leaf holding device 111 is configured to removably secure loose leaf 113 to the loose leaf retaining device 100. As used herein, “loose leaf” refers to one or more sheets of paper, paper products, cardboard, plastic, metal, carbon fiber, fiberglass, fabric or any other sheeted material.

In one embodiment, loose leaf retaining device 100 includes one or more first engagement members 118 and one or more second engagement members 120. As used herein, the engagement members may also be referred to as anti-slide devices. In one embodiment, first engagement member 118 is an indented portion (e.g., valley) and second engagement member 120 is a raised portion. First engagement member 118 is configured to interconnect with second engagement member 120. In one embodiment, first engagement member 118 is formed as a substantially inverse shape of second engagement member 120. In another embodiment, second engagement member 120 has a circumference sized larger than a circumference of first engagement member 118, which may facilitate self-location/interconnection of second engagement member 120 with first engagement member 118.

In one embodiment, a plurality of first engagement members 118 and/or second engagement members are formed on at least one of first panel 102 and second panel 104. In another embodiment, a plurality of engagement members 118 and/or 120 are formed in a predetermined pattern, such as a grid pattern. In other embodiments, the plurality of engagement members 118 and/or 120 are formed in a random arrangement.

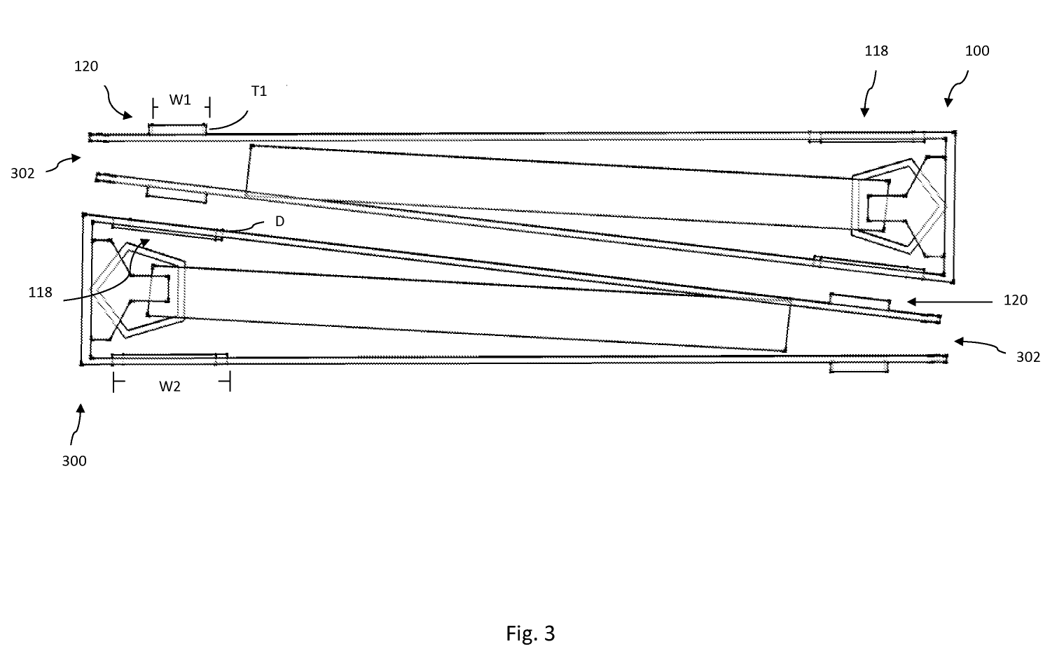

As shown in FIG. 3, for example, second engagement member 120 may have a thickness T1, measured from a plane of the first panel 102 or second panel 104 from which it extends, within a range of from about 1 mm to about 30 mm. However, the thickness T1 may be any thickness that allows the loose leaf retaining device to function as described herein. First engagement member 118 may have a depth D, measured from a plane of the first panel 102 or second panel 104 from which it is depressed, of from about 1 mm to about 30 mm. However, depth D may be any depth that allows the loose leaf retaining device to function as described herein. In some embodiments, thickness T1 is substantially equal to depth D. In other embodiments, thickness T1 is greater than or less than depth D. First engagement member 118 has a width W2 and second engagement member 120 has a width W1. In one embodiment, width W1 is less than or equal to width W2. Width W1 and W2 are sized within a range of from about 1 mm to about 30 cm, for example, 1-5 mm, 5-10 mm, 2-3 mm, 3-5 mm, 5-7 mm, 7-9 mm, 10-15 mm, 15-20 mm, 20-30 mm.

In one embodiment, first engagement member 118 and second engagement member 120 have substantially similar cross-sectional shapes, such as circular, polygonal, curved, triangular, oval, rectangular and the like. In other embodiments, first engagement member 118 and second engagement member 120 have different cross sectional shapes. In another embodiment, loose leaf retaining device 100 includes a plurality of first engagement members 118 and second engagement members 120. Each of the plurality of first engagement members 118 and second engagement members 120 may have a different size and or shape. For example, a first one of the first engagement members 118 may have a cross-sectional shape of a circle, and a first one of the second engagement members may have a similar circular cross section. A second one of the first engagement members 118 may have a triangular cross section and a second one of the second engagement members may have a similar triangular cross section, thus when another correspondingly shaped loose leaf retaining device is placed next to the original loose leaf retaining device 100, the engagement members are configured to interconnect in only one orientation. For example, as shown in FIG. 3, loose leaf retaining device 100 is in a first orientation, such that the opening 302 is disposed toward a left side and loose leaf retaining device 300 (e.g., a substantially similar loose leaf retaining device to loose leaf retaining device 100), is disposed at a second, opposite/inverted position as compared to loose leaf retaining device 100 such that the opening 302 is disposed toward a right side.

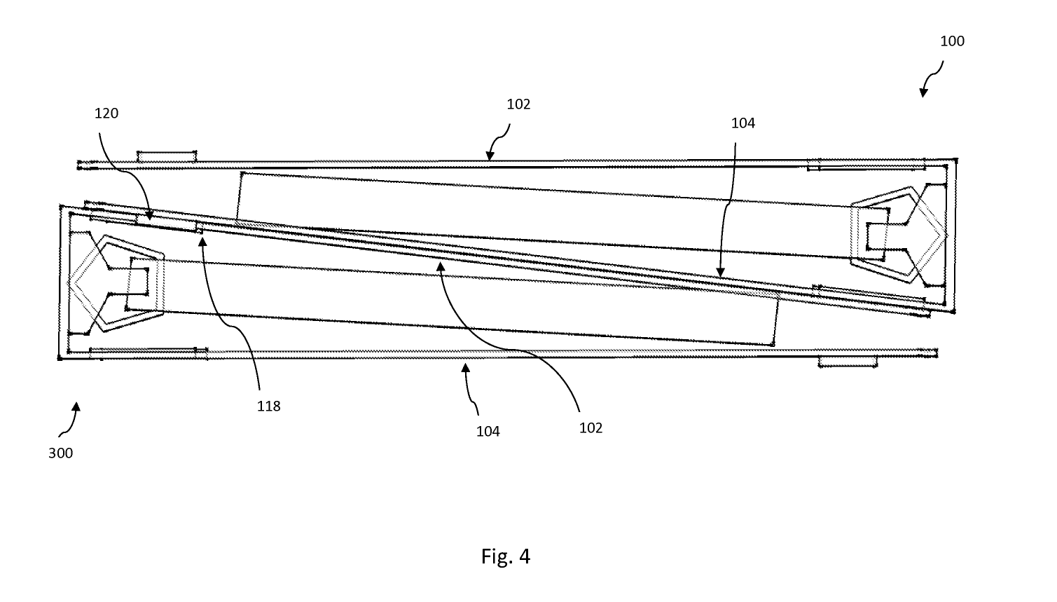

In operation, a user substantially aligns first engagement member(s) 118 of loose leaf retaining device 100 with second engagement member(s) 120 of loose leaf retaining device 300, as shown for example in FIG. 4. Second engagement member 120 is disposed at least partially within first engagement member 118, thus substantially preventing second panel 104 of loose leaf retaining device 100 from sliding along first panel 102 of loose leaf retaining device 300.

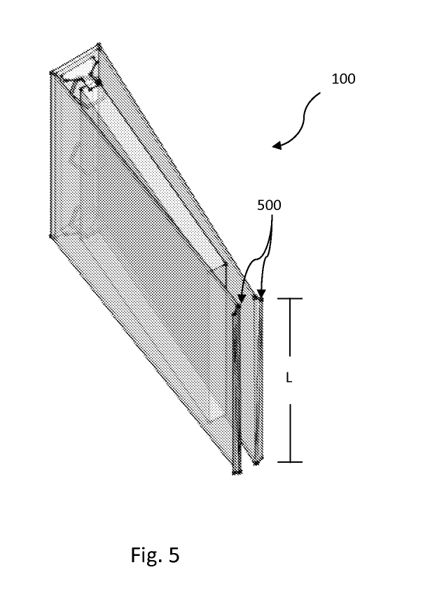

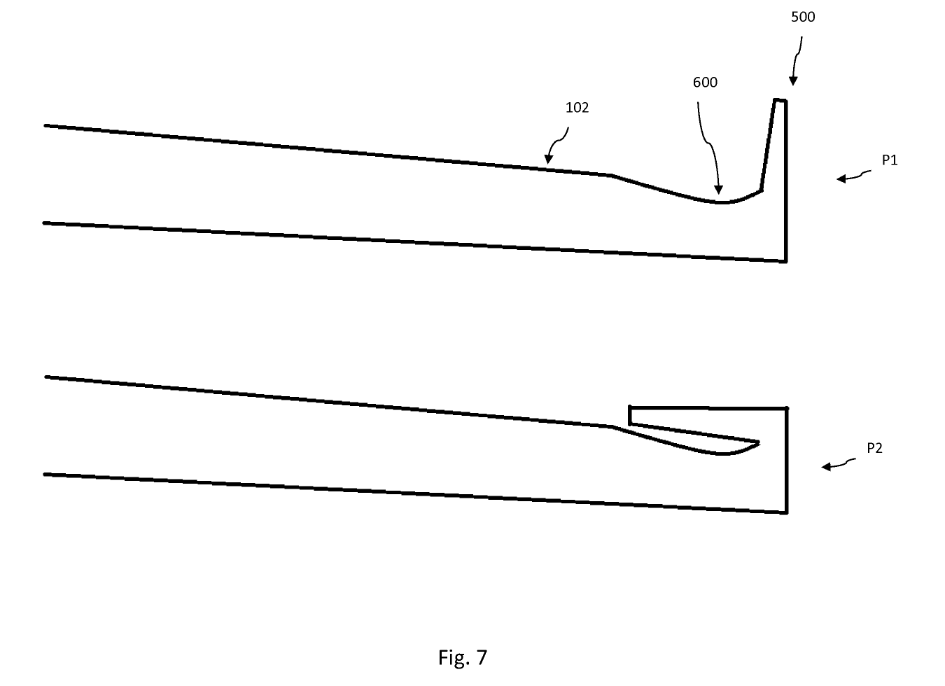

In one embodiment, as shown for example, in FIG. 5, loose leaf retaining device 100 includes one or more ridges 500 disposed at or near an opening-side edge of one or more of first panel 102 and second panel 104 of loose leaf retaining device 100. Ridge 500 has a length L. In one embodiment, length L is substantially equal to a length of the edge of first panel 102 or second panel 104. In other embodiments, length L is less than a length of the edge of first panel 102 or second panel 104. In one embodiment, ridge 500 has a height H, measured from a plane of the first panel 102 or second panel 104 from which it is extended, of from about 1 mm to about 30 mm. In another embodiment, one or more of ridge(s) 500 are hingedly, flexibly, retractably or bendably connected to first panel 102 and/or second panel 104 at a base portion 502, such that ridge 500 is capable of being disposed in a first position P1 that is substantially perpendicular to first panel 102 or second panel 104 and a second position P2 that is substantially parallel (i.e., co-planar) with first panel 102 or second panel 104. In another embodiment, as shown for example in FIG. 7 at least one of first panel 102 and second panel 104 include a ridge accepting portion 600 sized and configured to accept ridge 500 in position P2 such that ridge 500 does not substantially protrude from first panel 102 or second panel 104 from which it is connected. In one embodiment, loose leaf retaining device 100 includes a plurality of ridges 500, spaced apart from one another. In another embodiment, the plurality of ridges are disposed substantially linearly.

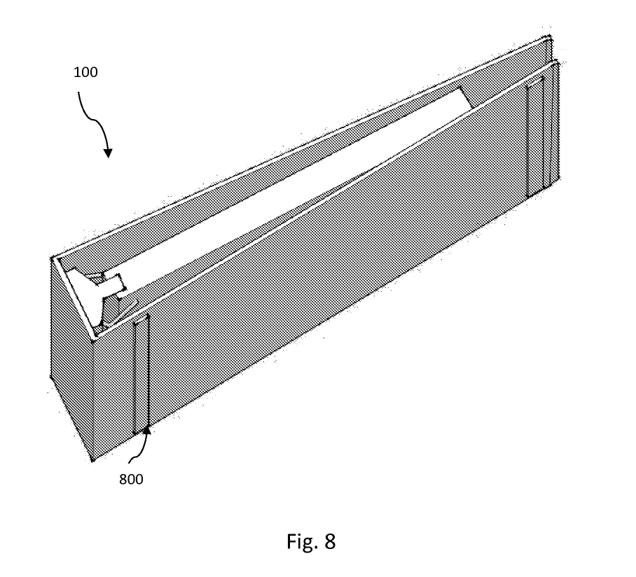

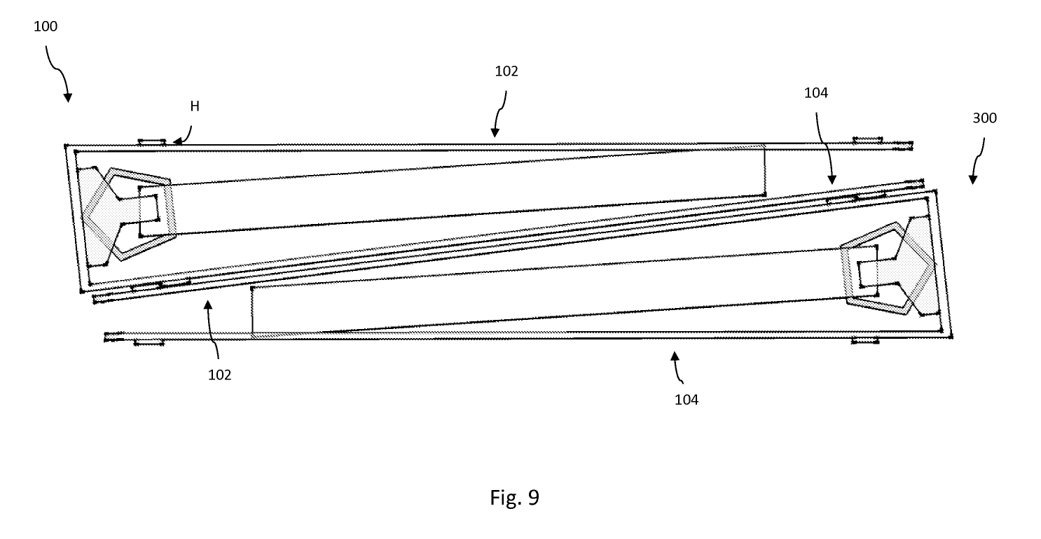

In one embodiment, as shown for example in FIG. 8, loose leaf retaining device 100 includes one or more platforms 800. In one embodiment, platforms 800 are raised platforms, that have a height H extending from at least one of first panel 102 and second panel 104, as shown for example in FIG. 9. Platforms 800 have a cross sectional shape of circular, polygonal, curved, triangular, oval, rectangular, and the like or sections of a circle, polygon, triangle and the like. Each platform 800 may have the same cross-sectional shape, or each platform 800 may have a different cross sectional shape. In other embodiments, each platform may include multiple cross-sectional shapes.

As shown in FIG. 9, for example, a first loose leaf retaining device 100 including one or more platforms 800 may be placed adjacent a second loose leaf retaining device 300 having one or more platforms 800. In one embodiment, the platforms are configured to abut one another to substantially prevent sliding in at least one direction. In other embodiments, platforms 800 may be configured to prevent sliding in multiple directions, for example, by using platforms having a non-linear shape, such as a T, L, Z or + shape and the like.

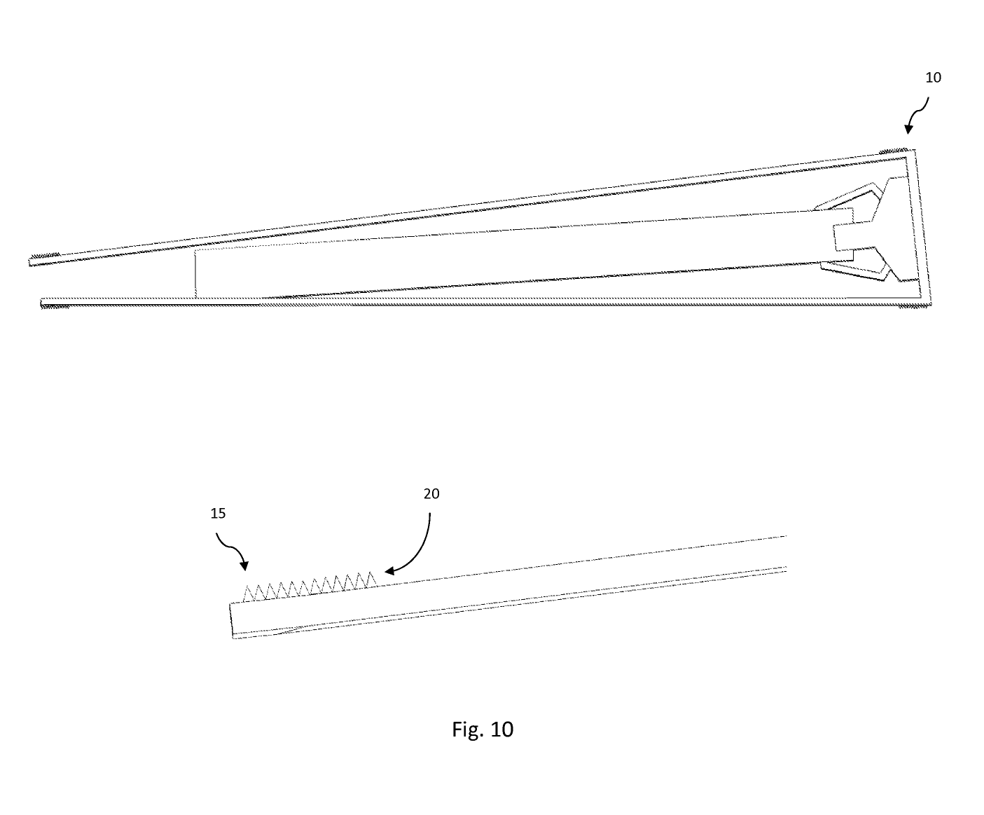

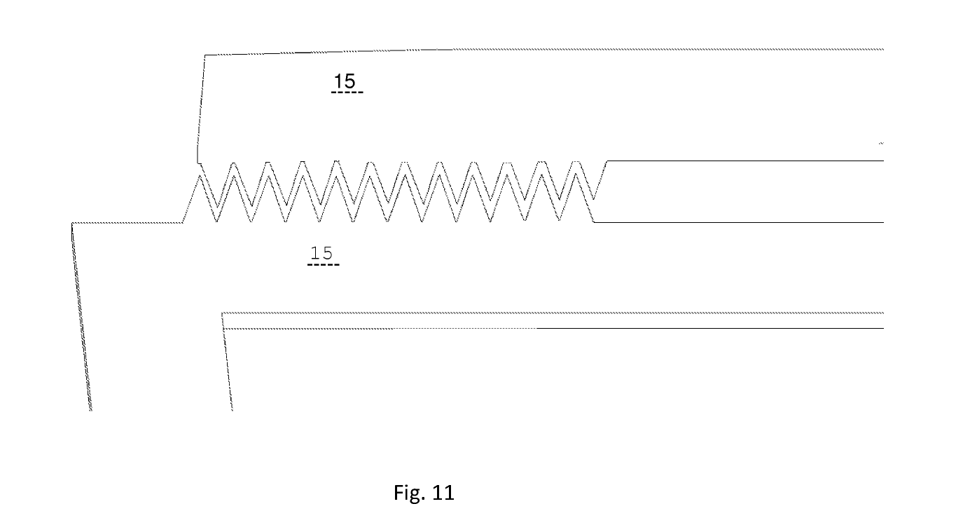

In one embodiment, as shown in FIG. 10, at least one of first panel 102 and second panel 104 include a wavy portion 10, having a wave shaped cross-section 15, such as a repeating up-and-down pattern (e.g., a plurality of alternating ridges and valleys). In embodiments, cross section 15 is in the shape of a triangular wave, a square wave, a rectangular wave, a sinusoidal wave and the like. In one embodiment, wavy portion 10 is a separate layer 20 formed on at least one of first panel 102 and second panel 104. In another embodiment, wavy portion 10 is formed integrally with at least one of first panel 102 and second panel 104. As shown in FIG. 11, two loose leaf retaining devices having similarly shaped or compatible wavy portions that may be positioned adjacent one another to be interconnected, and substantially prevent sliding of one loose leaf retaining device with respect to the other. Although orientations of 0 degrees and 180 degrees are most likely to be used, in other embodiments the orientations allow for interconnection of other angles, such as 90 degrees and 270 degrees, 45 degrees and any other angle that allows the loose leaf retaining devices to function as described herein.

In one embodiment, loose leaf retaining device 100 includes at least a portion including a high-friction material, such as a bead of a high-friction material. Such high-friction material may be disposed at or near, or form, at least one of first engagement member 118, second engagement member 120, ridge 500, platform 800 or wavy portion 10. In other embodiments, the high friction material is disposed along an entirety of or a portion of at least one of first panel 102 and second panel 104. In yet other embodiments, the high friction material may include a hook-and-loop type material and the like. As used herein, the term “high-friction material” includes any material having a coefficient of friction that substantially prevents two adjacent loose leaf retaining devices from sliding relative to one another when adjacent or interconnected, as described herein. In some embodiments, the high friction material includes one or more of rubber, silicone, adhesives, metals, metal alloys, carbon fiber, fiberglass, sandpaper, hook-and-loop fasteners, plastic, fabric, polymers, natural fibers and the like. As used herein, the term “interconnected” may include two surfaces abutting one another such that they are removably secured to one another, including magnetically secured, without causing significant structural damage to the abutting surfaces when detached after being interconnected.

In one embodiment, one or more of first engagement member 118, second engagement member 120, ridge 500, platform 800 or wavy portion 10 is retractable.

Each embodiment described herein is intended to be non-limiting, and may include one or more aspects of each and/or every other embodiment described herein.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A loose leaf retaining device comprising:
a first panel and a second panel opposing the first panel;
a connecting portion that pivotally connects the first panel to the second panel, such that in a closed state, the first panel is disposed at a non-zero angle relative to the second panel;
wherein at least one of the first panel and the second panel comprises an engagement member for engagement with another loose leaf retaining device.

2. The loose leaf retaining device according to claim 1, wherein the engagement member is configured to secure the loose leaf retaining device to another loose leaf retaining device.

3. The loose leaf retaining device according to claim 1, wherein the engagement member comprises at least one of a high-friction substance for non-slip engagement with another loose leaf retaining device.

4. The loose leaf retaining device according to claim 2, comprising a plurality of engagement members, and the engagement members are arranged in a predetermined pattern.

5. The loose leaf retaining device according to claim 1, wherein the engagement member comprises at least one raised portion disposed at an edge of the one of the first panel and the second panel.

6. The loose leaf retaining device according to claim 1, wherein the engagement member comprises one or more indentations configured for interconnecting engagement with one or more corresponding raised portions of another loose leaf retaining device.

7. The loose leaf retaining device according to claim 1, wherein the engagement member comprises at least one raised ridge and at least one valley.

8. A loose leaf retaining system, comprising:
a first binder comprising a first panel and a second panel, the first panel being pivotally connected to the second panel thereof;
a second binder comprising a first panel and a second panel, the first panel being pivotally connected to the second panel thereof;
wherein at least one of the first panel and the second panel of the first binder comprises at least one engagement member and at least one of the first panel and the second panel of the second binder comprises at least one engagement member configured to interconnect with the engagement member of the first binder.

9. The loose leaf retaining system according to claim 8, wherein the first binder comprises at least one raised retaining portion and the second binder comprises at least one corresponding depression.

10. The loose leaf retaining system according to claim 8, wherein the depression and the raised portion are configured to substantially prevent slippage of the first binder with respect to the second binder when interconnected.

11. The loose leaf retaining system according to claim 8, wherein the raised retaining portion and the corresponding depression have corresponding cross-sectional shapes.

12. The loose leaf retaining system according to claim 8, wherein the raised retaining portion is retractable.

13. The loose leaf retaining system according to claim 8, wherein at least one of the first panel of the first binder, the second panel of the first binder, the first panel of the second binder and the second panel of the second binder comprises a raised portion comprising a high-friction substance.

14. The loose leaf retaining system according to claim 8, wherein the first binder is configured to interconnect with the second binder placed at approximately 180 degrees in relation to the first binder.

15. A loose leaf binder, comprising:
a first panel, a second panel and a third panel, the third panel disposed intermediate the first panel and the second panel, the third panel being pivotally connected to the first panel along a first edge and pivotally connected to the second panel along a second edge;
at least one of the first panel and the second panel comprising an engagement member configured for interconnecting with a corresponding engagement member of another loose leaf binder.

16. The loose leaf binder according to claim 15, comprising a plurality of the engagement members disposed in a grid pattern on at least one of the first panel and the second panel.

17. The loose leaf binder according to claim 15, comprising a plurality of the engagement members, wherein each of the first panel and the second panel comprise at least one of the engagement members.

18. The loose leaf binder according to claim 15, comprising a plurality of the engagement members being arranged in substantially parallel rows.

19. The loose leaf binder according to claim 18, wherein the plurality of engagement members comprise at least one depression and at least one raised portion configured to interconnect with the depression.

20. The loose leaf binder according to claim 15, wherein the engagement member comprises a detent at a distal end, in relation to the third panel, of at least one of the first panel and the second panel.
